(19) United States
(12) Patent Application Publication
(10) Pub. No.: US 2020/0389632 A1
(43) Pub. Date: Dec. 10, 2020

(54) PROJECTION CALIBRATION SYSTEM AND PROJECTION CALIBRATION METHOD THEREOF

(71) Applicant: Coretronic Corporation, Hsin-Chu (TW)

(72) Inventors: Chun-Lin Chien, Hsin-Chu (TW); Chung-Lung Yang, Hsin-Chu (TW); Yu-Kuan Chang, Hsin-Chu (TW)

(73) Assignee: Coretronic Corporation, Hsin-Chu (TW)

(21) Appl. No.: 16/894,898

(22) Filed: Jun. 8, 2020

Related U.S. Application Data
(60) Provisional application No. 62/859,201, filed on Jun. 10, 2019.

(30) Foreign Application Priority Data
Oct. 30, 2019 (CN) 201911042771.6

(51) Int. Cl. H04N 9/31

(52) U.S. Cl. CPC H04N 9/3194; H04N 9/3188

(57) ABSTRACT

A projection calibration system and a projection calibration method thereof are provided. A projection device projects test pictures onto a projection screen. Each test picture includes a pattern. A plurality of photosensitive elements are disposed on a frame of the projection screen and measure brightness sensing information when the projection device projects each test picture. In response to the pattern being changed from a first position in a first test picture to a second position in a second test picture, the brightness sensing information is changed from a first sensing value to a second sensing value. In response to the brightness sensing information being changed from the first sensing value to the second sensing value, a computing device determines picture boundary parameters according to the first position. The projection device performs image scaling according to the picture boundary parameters to project a calibrated picture aligned with the frame.

### CROSS-REFERENCE TO RELATED APPLICATION

This application claims the priority benefit of U.S. Provisional application Ser. No. 62/859,201, filed on Jun. 10, 2019 and China application serial no. 201911042771.6, filed on Oct. 30, 2019. The entirety of the above-mentioned patent application is hereby incorporated by reference herein and made a part of this specification.

### BACKGROUND OF THE INVENTION

### 1. Field of the Invention

The invention relates to a projection technology, and in particular, to a projection calibration system and a projection calibration method.

### 2. Description of Related Art

A projector is a display device for generating a large-size image. The imaging principle of the projector is to convert an illumination beam generated by a light source module into an image beam by a light valve device, and then project the image beam through a projection lens onto a projection screen or a wall to form an image. With the advancement of the projection technology and the reduction of manufacturing costs, the use of the projector has been expanded to various application scenarios. A touch projection system is a projection system for a user to perform a touch operation on the projection screen. A touch area of the projection screen is used to receive a touch input operation performed by the user, so that the user may interact intuitively with the projection system through the touch operation.

It is to be noted that in the touch projection system, the user often needs to perform alignment calibration on a projection image projected by the projector and the touch area provided by the projection screen, so that the projector may correctly perform subsequent actions in response to a touch operation received by the touch projection screen, thereby allowing the user to smoothly interact with the touch projection system. More specifically, a touch boundary of the touch area on the projection screen needs to be accurately aligned with an image content boundary in the projection image, and the touch projection system may accurately provide a function that meets the user's expectation for a touch position of the touch operation. In a conventional calibration method, the user may move a position of the projector or a position of the projection screen to adjust a size and shape of the projection picture, but the calibration method not only is easily limited by environmental restrictions but also is difficult to obtain an accurate calibration result. In addition, in another conventional calibration method, the touch projection system may perform alignment calibration of a touch boundary and an image content boundary by shooting a projection result via a camera, but the calibration method needs to consider camera parameters and camera calibration together and cannot perform, otherwise, accurate projection calibration. Alternatively, in another conventional calibration method, the user may manually set an image content boundary in the projection image to be reduced and perform alignment calibration by subjective judgment of human eyes, but the manual operation steps of the calibration method are cumbersome and time-consuming, which may be quite inconvenient for the user.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

In view of this, the invention provides a projection calibration system and a projection calibration method, which may perform projection alignment calibration efficiently and accurately, so that an image content boundary in a calibrated picture may be aligned with a frame of a projection screen.

An embodiment of the invention provides a projection calibration system, which includes a projection device, a plurality of photosensitive elements and a computing device. The projection device projects a plurality of test pictures onto a projection screen. Each test picture includes a pattern, and the test pictures include a first test picture and a second test picture. The plurality of photosensitive elements are disposed on a frame of the projection screen and measure brightness sensing information when the projection device projects each test picture. The computing device is coupled to the photosensitive elements and the projection device. In response to the pattern being changed from a first position in the first test picture to a second position in the second test picture, the brightness sensing information is changed from a first sensing value to a second sensing value. In response to the brightness sensing information being changed from the first sensing value to the second sensing value, the computing device determines picture boundary parameters according to the first position of the pattern in the first test picture. The projection device performs image scaling according to the picture boundary parameters to project a calibrated picture aligned with the frame of the projection screen.

An embodiment of the invention provides a projection calibration method, which includes the following steps. A projection device projects a plurality of test pictures onto a projection screen. Each test picture includes a pattern, and the test pictures include a first test picture and a second test picture. When each test picture is projected, a plurality of photosensitive elements on a frame of the projection screen measure brightness sensing information. In response to the pattern being changed from a first position in the first test picture to a second position in the second test picture, the brightness sensing information is changed from a first sensing value to a second sensing value. In response to the brightness sensing information being changed from the first sensing value to the second sensing value, picture boundary parameters are determined according to the first position of the pattern in the first test picture. Image scaling is performed according to the picture boundary parameters to project a calibrated picture aligned with the frame of the projection screen.

Based on the foregoing, in the embodiments of the invention, a projection device will project a plurality of test pictures including a pattern onto a projection screen, and a position of the pattern in each test picture is changed. Moreover, when the projection device projects the test pictures onto the projection screen, photosensitive elements disposed on a frame of the projection screen are adopted to measure brightness information of the test pictures. Since the position of the pattern changes as the test pictures are switched, a position of the photosensitive element relative to a projection range may be detected by continuously sensing brightness sensing information, thereby determining picture boundary parameters according to the position of the photosensitive element relative to the projection range. Therefore, the projector performs image scaling according to the picture boundary parameters to generate a calibrated picture that may be aligned with the frame of the projection screen, thereby providing an efficient and convenient projection calibration method.

To make the features and advantages of the invention clear and easy to understand, the following gives a detailed description of embodiments with reference to accompanying drawings.

Other objectives, features and advantages of the invention will be further understood from the further technological features disclosed by the embodiments of the invention where there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection calibration system according to an embodiment of the invention.

FIG. 2 is a flow chart of a projection calibration method according to an embodiment of the invention.

FIG. 3A and FIG. 3B are examples of a test picture according to an embodiment of the invention.

FIG. 4 is a schematic diagram of a calibrated picture according to an embodiment of the invention.

FIG. 5 is a schematic diagram of a projection device according to an embodiment of the invention.

FIG. 6 is a schematic diagram of generating a test picture based on a pattern position parameter according to an embodiment of the invention.

FIG. 7 is a schematic diagram of generating a test picture based on a pattern compression deformation parameter according to an embodiment of the invention.

FIG. 8A and FIG. 8B are schematic diagrams of a projection calibration method according to an embodiment of the invention.

FIG. 9A and FIG. 9B are schematic diagrams of a projection calibration method according to an embodiment of the invention.

FIG. 10 is a schematic diagram of a projection calibration method according to an embodiment of the invention.

FIG. 11 is a flow chart of a projection calibration method according to an embodiment of the invention.

### DESCRIPTION OF THE EMBODIMENTS

Embodiments of the invention will be illustrated below with the accompanying drawings. The directional terms mentioned in the invention, like “above”, “below”, “front”, “back”, “left”, and “right”, refer to the directions in the appended drawings. Therefore, the directional terms are only used for illustration instead of limiting the invention.

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

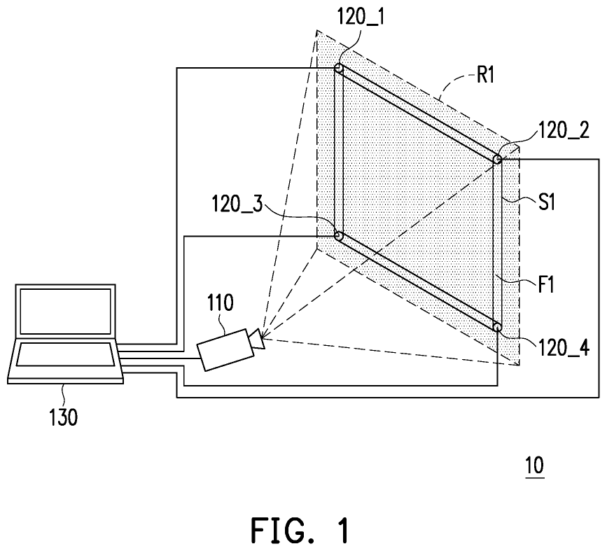

FIG. 1 is a schematic diagram of a projection calibration system according to an embodiment of the invention. Referring to FIG. 1, a projection calibration system 10 includes a projection device 110, a plurality of photosensitive elements 120_1-120_4, a projection screen S1, and a computing device 130.

The projection device 110 may project an image onto the projection screen S1, and may be a Liquid Crystal Projector (LCP), a Digital Light Processing (DLP) projector, or a Liquid Crystal On Silicon (LCOS) projection display device, etc. In the embodiment, the projection device 110 may further include a light source module, a light engine module, a lens module, and related optical and circuit control elements, etc. For example, the projection device 110 may further include an image processing circuit for performing image processing.

The projection screen S1 is configured to display a projection image projected by the projection device 110 and has a frame F1. In an embodiment, the touch-type projection screen S1 may include the frame F1 and a touch panel embedded in the frame F1. The touch-type projection screen S1 may display a projection image according to an image beam projected by the projection device 110 and detect a touch operation operated by a user. The touch-type projection screen S1 may be a capacitive touch projection screen, an electromagnetic touch projection screen, a resistive touch projection screen or other suitable touch projection screens, which is not limited by the invention. In addition, in an embodiment, the projection screen S1 may further include the frame F1 and other display media that are embedded in the frame F1 and have no touch function, such as a projection curtain.

The photosensitive elements 120_1-120_4 are disposed on the frame F1 of the projection screen S1. In the embodiment, the photosensitive elements 120_1-120_4 may be configured to sense the brightness of the projection image to output brightness sensing values. The photosensitive elements 120_1-120_4 are, for example, Charge Coupled Devices (CCD), Complementary Metal-Oxide Semiconductor (CMOS) elements, or other elements. In other embodiments, the photosensitive elements 120_1-120_4 may be, for example, a color sensor for detecting the chromaticity of colored light, which is not limited by the invention. In an embodiment, the photosensitive elements 120_1-120_4 are respectively located at a plurality of corners of the frame F1 of the projection screen S1, and a projection range R1 of the projection device 110 covers at least the frame F1.

It is to be noted that FIG. 1 shows an example that there are four photosensitive elements 120_1-120_4 respectively disposed on four corners of the frame F1 of the projection screen S1. However, the invention does not limit the number and arrangement position of the photosensitive elements, which may be set depending on the actual application. For example, the frame is rectangular shaped and is formed by four sides, and the number of photosensitive elements may also be other numbers, for example, 2 or 8, etc., and the photosensitive elements may be disposed, for example, at an intermediate point of each side of the frame, etc. It is to be noted that in an embodiment, in order to obtain a rectangular display boundary defined by the frame F1 according to a brightness measurement result generated by the photosensitive elements, there are at least two photosensitive elements located on two corners of diagonal lines of the frame F1 respectively.

The computing device 130 is coupled to the projection device 110 and the plurality of photosensitive elements 120_1-120_4, and includes a memory and at least one processor coupled to the memory. The computing device 130 may be a computer control system with computing capability such as a desktop computer, a notebook computer, a work station, an industrial computer, or a server host. The memory may be any type of non-transitory, volatile and non-volatile data storage device for storing buffered data, permanent data, and compiler codes for performing the functions of the computing device 130. The processor may be a Field Programmable Array (FPGA), a Programmable Logic Device (PLD), an Application Specific Integrated Circuits (ASIC), other similar devices, or a combination of the devices. The processor may also be a Central Processing Unit (CPU) or other programmable general purpose or special purpose microprocessors, a Digital Signal Processor (DSP), a Graphics Processing Unit (GPU), other similar devices, or a combination of the devices.

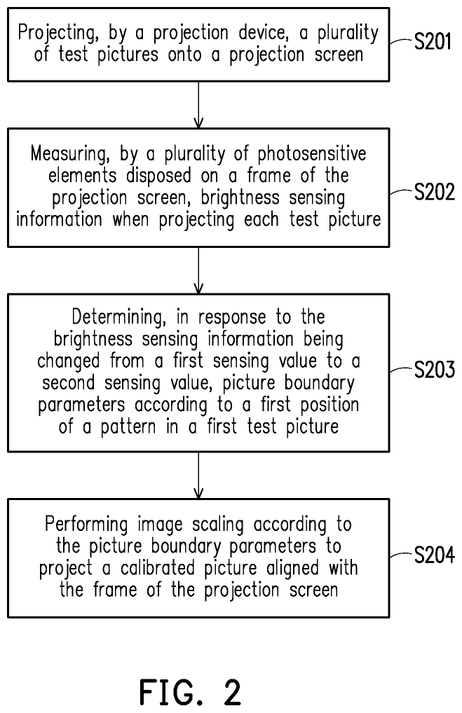

FIG. 2 is a flow chart of a projection calibration method according to an embodiment of the invention. The method flow of FIG. 2 may be implemented by various elements of the projection calibration system 10 of FIG. 1. Referring to FIG. 1 and FIG. 2 together, the steps of the projection calibration method of the embodiment will be described below with reference to various elements of the projection calibration system 10 in FIG. 1.

In step S201, a projection device 110 projects a plurality of test pictures onto a projection screen S1. The projection device 110 projects an image beam onto the projection screen S1, and a projection range R1 of the projection device 110 is wider than the projection screen S1 to cover at least a frame F1 of the projection screen S1. In other words, the test pictures projected by the projection device 110 within the projection range R1 may cover photosensitive elements 120_1-120_4.

In an embodiment, each test picture includes a pattern and a picture background. The pattern may include a horizontal bar, a vertical bar, or a combination thereof. Also, the colors of the pattern and the picture background are different from each other. For example, the pattern may be white and the picture background may be black, but the invention is not limited thereto. It is to be noted that the positions of the patterns in the test pictures are varied with time. In other words, when the projection device 110 switches projection of one of the test pictures to projection of another of the test pictures, a display position of the pattern will be varied. That is, when different test pictures are presented on the projection screen S1, a distance between the display position of the pattern and the frame F1 will vary.

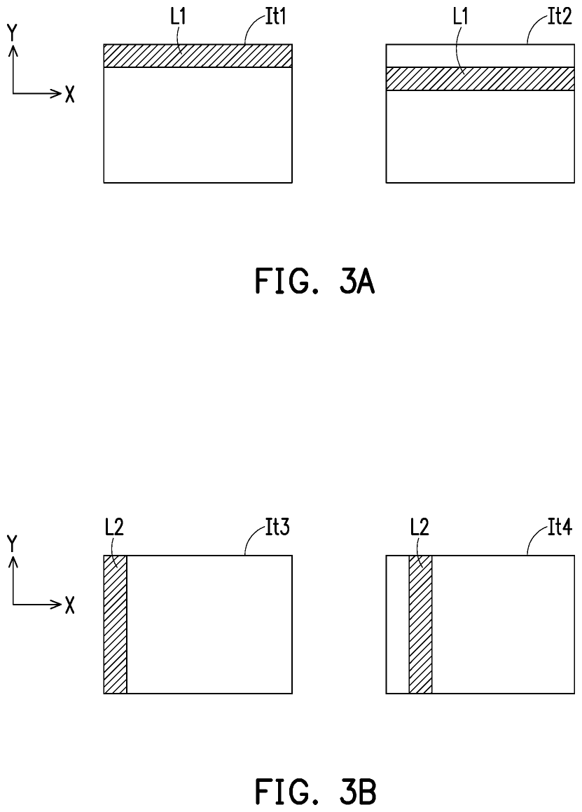

For example, FIG. 3A and FIG. 3B are examples of a test picture according to an embodiment of the invention. Referring to FIG. 3A, assuming that the pattern is a white horizontal bar L1 (illustrated by a hatched area in the figure) and the picture background is black, the projection device 110 may generate two test pictures It1 and It2 by changing a position of the white horizontal bar L1 along a vertical axis (i.e., Y axis). That is, the test picture It1 may include a white horizontal bar L1 at an edge of the picture. The test picture It2 may include a white horizontal bar L1 close to the edge of the picture. Referring to FIG. 3B, assuming that the pattern is a white vertical bar L2 (illustrated by a hatched area in the figure) and the picture background is black, the projection device 110 generates two test pictures It3 and It4 by changing a position of the white vertical bar L2 along a horizontal axis (i.e., X axis). That is, the test picture It3 may include a white vertical bar L2 at the edge of the picture. The test picture It4 may include a white vertical bar L2 close to the edge of the picture. Details of the implementation of the projection device 110 to generate a test picture will be described hereinafter. However, FIG. 3A and FIG. 3B are illustrated with two test pictures, but the invention does not limit the number of test pictures.

Then, in step S202, when each test picture is projected sequentially, a plurality of photosensitive elements 120_1-120_4 disposed on a frame F1 of the projection screen S1 measure brightness sensing information. Specifically, when the projection device 110 projects each test picture, the plurality of photosensitive elements 120_1-120_4 measure brightness sensing information associated with each test picture at different positions on the frame F1, respectively, and the photosensitive elements 120_1-120_4 output the brightness sensing information to the computing device 130. In the example of FIG. 1, when the projection device 110 sequentially projects a plurality of test pictures, the photosensitive elements 120_1-120_4 may perform brightness measurement on the four corners of the frame F1, and output four brightness sensing values respectively corresponding to the corners and associated with each test picture.

In an embodiment, the first test picture and the second test picture displayed sequentially are taken for illustration. In response to the pattern being changed from a position (also referred to as a first position) in the first test picture to a position (also referred to as a second position) in the second test picture, the brightness sensing information sensed by some or all of the photosensitive elements 120_1-120_4 is changed from a first sensing value to a second sensing value. Here, the first sensing value is a measurement result of brightness sensing for the first test picture, and the second sensing value is a measurement result of brightness sensing for the second test picture.

In detail, since the colors of the patterns and the picture backgrounds in the test pictures are different, whether the pattern in the first test picture is overlaid and displayed above the photosensitive elements 120_1-120_4 may affect the brightness sensing results of the photosensitive elements 120_1-120_4. That is, the brightness sensing values output by the photosensitive elements 120_1-120_4 may be used to response whether the display position of the pattern is overlapping the measurement positions of the photosensitive elements 120_1-120_4. For example, if the display position of the pattern in a certain test picture overlaps the measurement position of the photosensitive element 120_1, the photosensitive element 120_1 will output a first sensing value. If the display position of the pattern in a certain test picture does not overlap the measurement position of the photosensitive element 120_1, the photosensitive element 120_1 will output a second sensing value different from the first sensing value. In an embodiment, the first sensing value and the second sensing value generated by the photosensitive elements 120_1-120_4 for brightness sensing are dependent on an environmental light source and colors of the patterns and the picture backgrounds in the test pictures.

Therefore, in step S203, in response to the brightness sensing information being changed from the first sensing value to the second sensing value, the computing device 130 may determine picture boundary parameters according to the first position of the pattern in the first test picture. More specifically, when the computing device 130 determines that the brightness sensing information generated by one of the photosensitive elements 120_1-120_4 is changed from the first sensing value to the second sensing value, it is indicated that the first position of the pattern in the first test picture overlaps the measurement position of one of the photosensitive elements 120_1-120_4. Therefore, the computing device 130 may acquire position information of a corner of the frame F1 relative to a projection range R1 according to the first position of the pattern in the first test picture and determine picture boundary parameters accordingly.

In an embodiment, when the brightness sensing information generated by the photosensitive elements 120_1-120_4 is changed from the first sensing value corresponding to a white pattern to the second sensing value corresponding to a black picture background respectively, the computing device 130 may detect positions of four corners of the frame F1 relative to the projection range R1 according to the pattern position corresponding to the first sensing value and determine picture boundary parameters accordingly. In an embodiment, the picture boundary parameters include upper and lower boundary parameters, left and right boundary parameters, or a combination thereof, which may be used to define an ideal display boundary defined by the frame F1 in the projection range R1. For example, in the example of FIG. 1, since the photosensitive elements 120_1-120_4 are respectively located at four corners of the frame F1 for brightness sensing, the left and right boundary parameters may include four X-axis coordinate values and the upper and lower boundary parameters may include four Y-axis coordinate values. The four X-axis coordinate values and the four Y-axis coordinate values may be regarded as the positions of the four corners of the frame F1 within the projection range R1. In summary, by sequentially projecting a plurality of test pictures and enabling the photosensitive elements 120_1-120_4 to continue performing brightness sensing, the computing device 130 may estimate an ideal display boundary defined by the frame F1 in the projection range R1 according to the brightness sensing information output by the photosensitive elements 120_1-120_4.

Then, in step S204, the projection device 110 may perform image scaling according to the picture boundary parameters to project a calibrated picture aligned with the frame F1 of the projection screen S1. In an embodiment, the projection device 110 may reduce a size of an original image from the computing device 130 according to the picture boundary parameter and fill a periphery of the size-reduced original image with a peripheral image block to generate the calibrated picture. It is to be noted that an image edge of the size-reduced original image in the calibrated picture is aligned with the frame F1. In other words, an image content boundary of the size-reduced original image will be aligned with the frame F1, so that the image content of the size-reduced original image in the calibrated picture is presented inside the frame F1, and a black peripheral image block in the calibrated picture will be presented outside the frame F1.

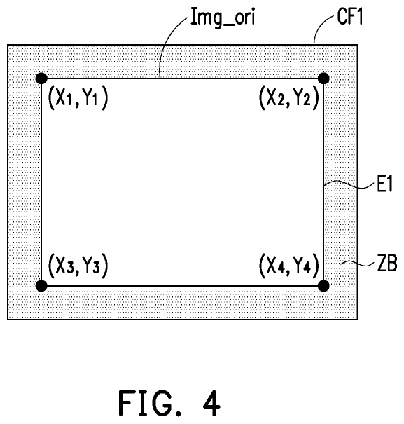

For example, FIG. 4 is a schematic diagram of a calibrated picture according to an embodiment of the invention. Referring to FIG. 4, with reference to the example of FIG. 1, if the picture boundary parameters may include four X-axis coordinate values X₁, X₂, X₃, and X₄ and four Y-axis coordinate values Y₁, Y₂, Y₃, and Y₄, the projection device 110 may perform image deformation processing including image scaling on an original image Img_ori according to the above eight coordinate values to generate a size-reduced original image Img_ori. In addition, the projection device 110 fills a periphery of the size-reduced original image Img_ori with a peripheral image block ZB according to the above eight coordinate values to generate a calibrated picture CF1 including the size-reduced original image Img_ori and the peripheral image block ZB. The positions of four corner pixels of the size-reduced original image Img_ori located in the calibrated picture CF1 are (X₁, Y₁), (X₂, Y₂), (X₃, Y₃), and (X₄, Y₄), respectively. When the projection device 110 projects the calibrated picture CF1, an image content boundary E1 of the size-reduced original image Img_ori will be aligned with the frame F1 of the projection screen S1.

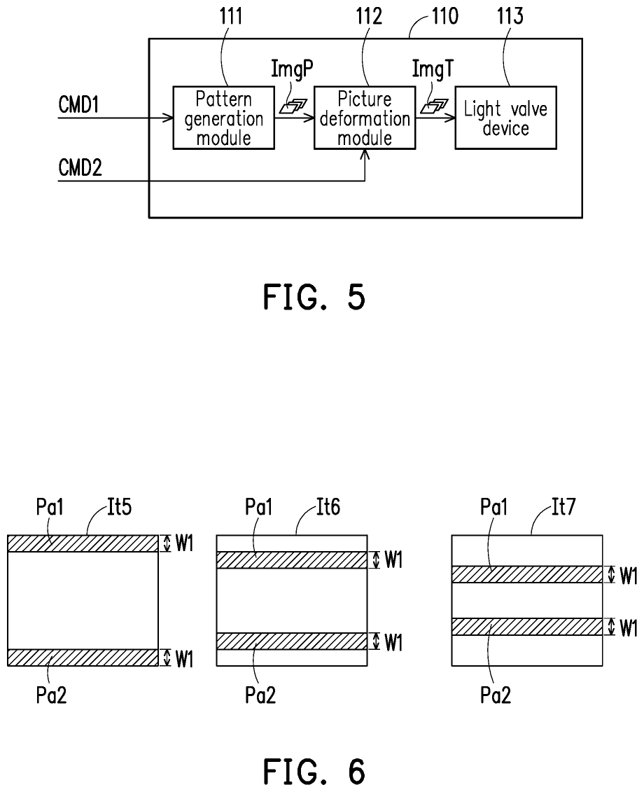

FIG. 5 is a schematic diagram of a projection device according to an embodiment of the invention. Referring to FIG. 5, the projection device 110 may include a pattern generation module 111, a picture deformation module 112 and a light valve device 113. The pattern generation module 111 and the picture deformation module 112 may be implemented by, not limited to, a software program, firmware, a hardware circuit, or a combination thereof. The light valve device 113 is, for example, a transmissive Liquid Crystal Display (LCD) panel, a Liquid Crystal On Silicon (LCOS) panel, or a Digital Micromirror Device (DMD).

In an embodiment, the projection device 110 may generate a plurality of test pictures according to pattern parameters provided by the computing device 130. The position of the pattern in each test picture is determined according to the pattern parameters, and the pattern parameters may include a pattern position parameter CMD1 or a pattern compression deformation parameter CMD2. The pattern generation module 111 may acquire the pattern position parameter CMD1 from the computing device 130 and generate at least one pattern picture ImgP according to the pattern position parameter CMD1 from the computing device 130. The picture deformation module 112 may acquire the pattern compression deformation parameter CMD2 from the computing device 130 and perform picture deformation processing according to the pattern compression deformation parameter CMD2. Two implementation manners for generating test pictures are listed below.

In an embodiment, the pattern generation module 111 of the projection device 110 may generate a plurality of pattern pictures ImgP as a plurality of test pictures ImgT according to the pattern position parameters CMD1 respectively. That is, the picture deformation module 112 does not perform image deformation processing, and the plurality of pattern pictures ImgP generated by the pattern generation module 111 are used as the plurality of test pictures ImgT. The plurality of test pictures ImgT are transmitted to the light valve device 113. In addition, in response to the change of the pattern position parameters CMD1, the patterns are respectively located at different positions in the plurality of pattern pictures ImgP. For example, the positions of the patterns respectively located in the plurality of pattern pictures ImgP will be changed with time from the edges of the pictures to the centers of the pictures, so that the pattern projected by the light valve device 113 may gradually approach the photosensitive elements 120_1-120_4 with the projection of the test pictures ImgT one by one. It is to be noted that since the picture deformation module 112 does not perform image deformation processing, the sizes of the patterns in the plurality of pattern pictures ImgP are fixed.

For example, FIG. 6 is a schematic diagram of generating a test picture based on a pattern position parameter according to an embodiment of the invention. Referring to FIG. 5 and FIG. 6, the pattern is set to include two horizontal bars Pa1 and Pa2, and a pattern picture generated by the pattern generation module 111 is used as a test picture. First, the pattern generation module 111 may first generate a test picture It5 (pattern picture) according to the pattern position parameter CMD1. The test picture It5 includes horizontal bars Pa1 and Pa2 located at upper and lower picture edges, and the widths of the horizontal bars Pa1 and Pa2 in the test picture It5 are both W1 (pixel unit). Then, the pattern generation module 111 may first generate a test picture It6 (pattern picture) according to the pattern position parameter CMD1. The test picture It6 includes horizontal bars Pa1 and Pa2 close to upper and lower picture edges, and the widths of the horizontal bars Pa1 and Pa2 in the test picture It6 are both W1, where the horizontal bars Pa1 and Pa2 in the test picture It6 are closer to the center of the test picture than the horizontal bars Pa1 and Pa2 in the test picture It5. Next, the pattern generation module 111 may first generate a test picture It7 (pattern picture) according to the pattern position parameter CMD1. The test picture It7 includes horizontal bars Pa1 and Pa2 close to upper and lower picture edges, and the widths of the horizontal bars Pa1 and Pa2 in the test picture It7 are both W1, where the horizontal bars Pa1 and Pa2 in the test picture It7 are closer to the center of the test picture than the horizontal bars Pa1 and Pa2 in the test picture It6. The pattern position parameters CMD1 corresponding to the test picture It5, It6, It7 are different. It can be seen that the two horizontal bars Pa1 and Pa2 gradually move toward the center of the picture as the test pictures It5-It7 are sequentially displayed.

In addition, in an embodiment, the pattern generation module 111 of the projection device 110 may generate a pattern picture ImgP according to the constant pattern position parameter CMD1. The picture deformation module 112 of the projection device 110 compresses the height or width of the pattern picture ImgP according to the pattern compression deformation parameter CMD2 and fills a periphery of the compressed pattern picture with an image block to generate a plurality of test pictures ImgT. In more detail, in response to the change of the pattern compression deformation parameters CMD2, the pattern picture ImgP will be compressed according to different scaling factors to generate a plurality of test pictures ImgT, so the sizes of patterns in the plurality of test pictures ImgT are reduced according to the pattern compression deformation parameters CMD2. In addition, since the pattern generation module 111 generates a pattern picture ImgP according to the constant pattern position parameter CMD1, the position of a pattern in the pattern picture ImgP is fixed.

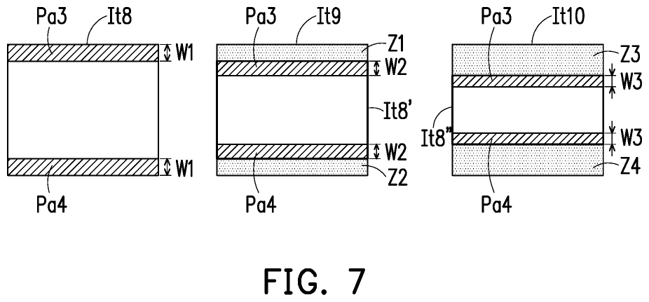

For example, FIG. 7 is a schematic diagram of generating a test picture based on a pattern compression deformation parameter according to an embodiment of the invention. Referring to FIG. 5 and FIG. 7, the pattern is set to include two horizontal bars Pa3 and Pa4. The pattern generation module 111 may first generate a pattern picture according to the pattern position parameter CMD1. The pattern compression deformation parameter CMD2 may be a scaling factor. First, in a case where the scaling factor is 1, the picture deformation module 112 may generate a test picture It8 according to the pattern compression deformation parameter CMD2. The test picture It8 includes horizontal bars Pa3 and Pa4 located at upper and lower picture edges, and the widths of the horizontal bars Pa3 and Pa4 in the test picture It8 are both W1 (pixel unit). Then, in a case where the scaling factor is changed to α (α<1), the picture deformation module 112 may generate a compressed pattern picture It8′ according to the height (length in a vertical direction) of a pattern picture compressed according to the pattern compression deformation parameter CMD2 and fill a periphery of the compressed pattern picture It8′ with image blocks Z1 and Z2 to generate a test picture It9. The widths of horizontal bars Pa3 and Pa4 in the test picture It9 are both W2, and W2 is less than W1. Then, in a case where the scaling factor is changed to β (β<α<1), the picture deformation module 112 may generate a compressed pattern picture It8″ according to the height (length in a vertical direction) of a pattern picture compressed according to the pattern compression deformation parameter CMD2 and fill a periphery of the compressed pattern picture It8″ with image blocks Z3 and Z4 to generate a test picture It10. The widths of horizontal bars Pa3 and Pa4 in the test picture It10 are both W3, and W3 is less than W2 and W1. It can be seen that the two horizontal bars Pa3 and Pa4 gradually move toward the center of the test picture as the test pictures It8-It10 are sequentially displayed.

The following will further explain how to acquire picture boundary parameters according to the test picture and the brightness sensing information of the photosensitive elements. For convenience of description, the following embodiment will be exemplified by a white pattern and a black picture background in the test picture.

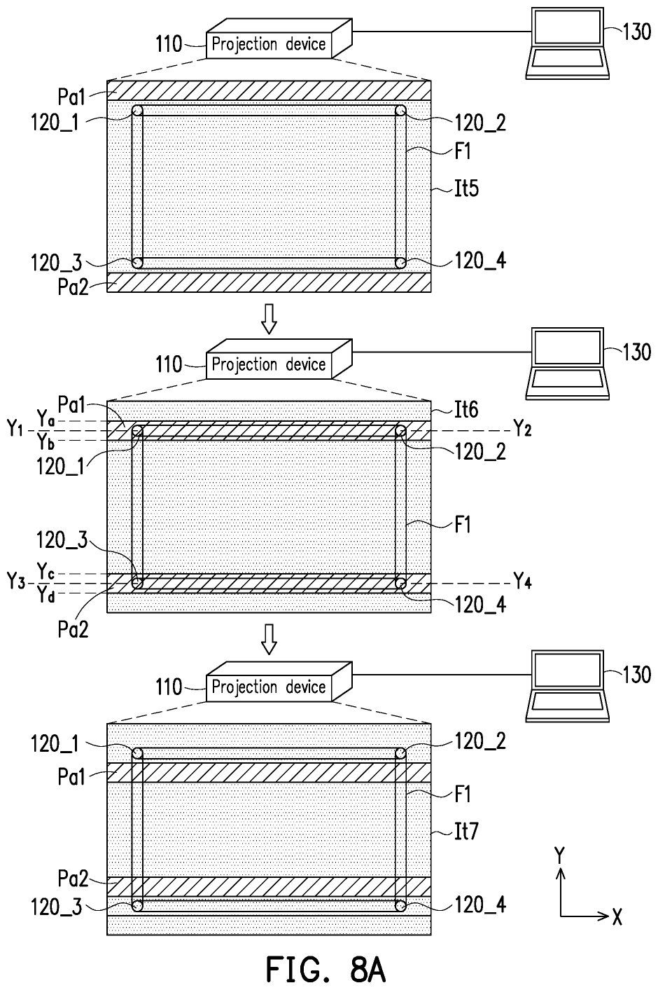

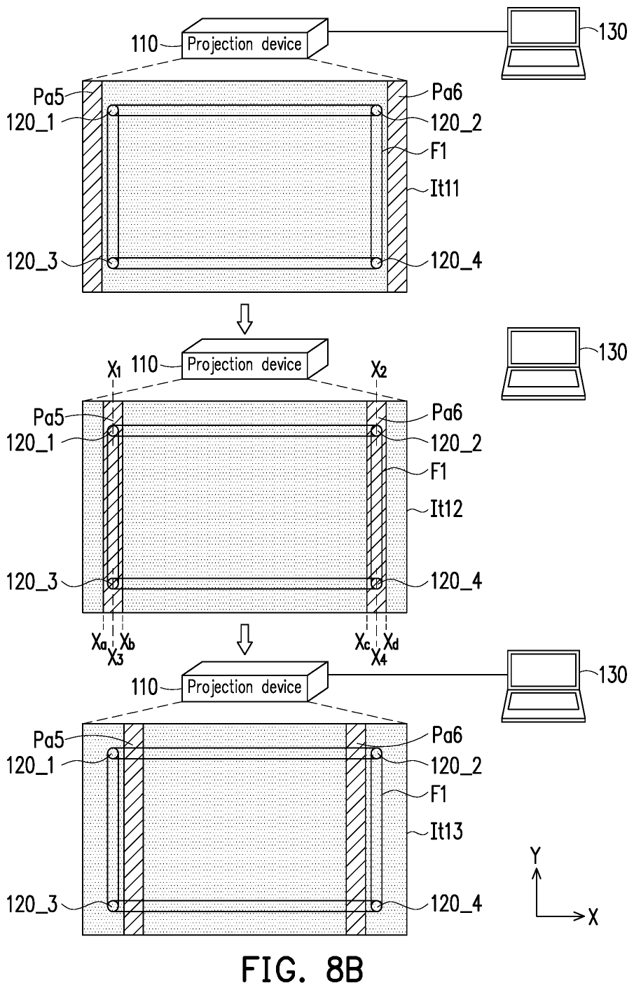

FIG. 8A and FIG. 8B are schematic diagrams of a projection calibration method according to an embodiment of the invention. FIG. 8A and FIG. 8B are exemplified by that a pattern position in the test picture is changed according to a pattern position parameter and a pattern size is fixed.

Referring to FIG. 8A, in a horizontal alignment calibration period, by taking test pictures It5-It7 of FIG. 6 as an example, the pattern may include two horizontal bars Pa1 and Pa2, and the positions of the two horizontal bars Pa1 and Pa2 will be changed as the test pictures It5-It7 are displayed sequentially.

First, the projection device 110 projects the test picture It5. Since the horizontal bars Pa1 and Pa2 in the test picture It5 projected by the projection device 110 do not cover the photosensitive elements 120_1-120_4, each photosensitive elements 120_1-120_4 senses a second sensing value associated with the black picture background of the test picture It5. The photosensitive elements 120_1-120_4 output the second sensing value to the computing device 130, so that the computing device 130 controls the projection device 110 to project the test picture It6. Since the horizontal bars Pa1 and Pa2 in the test picture It6 projected by the projection device 110 cover the photosensitive elements 120_1-120_4, each of the photosensitive elements 120_1-120_4 senses a first sensing value associated with the white pattern. The photosensitive elements 120_1-120_4 output the first sensing value to the computing device 130, so that the computing device 130 controls the projection device 110 to project the test picture It7.

Since the horizontal bars Pa1 and Pa2 in the test picture It7 projected by the projection device 110 do not cover the photosensitive elements 120_1-120_4, each of the photosensitive elements 120_1-120_4 senses a second sensing value associated with the black picture background. The photosensitive elements 120_1-120_4 output the second sensing value to the computing device 130. In response to the brightness sensing information of the photosensitive elements 120_1-120_4 being changed from the first sensing value to the second sensing value, the computing device 130 may determine upper and lower boundary parameters Y₁, Y₂, Y₃, and Y₄ according to the positions of the two horizontal bars Pa1 and Pa2 in the test picture It6. More specifically, by the scanning of the two horizontal bars Pa1 and Pa2, the computing device 130 may know that the photosensitive elements 120_1-120_4 are located in a coverage range of the horizontal bars Pa1 and Pa2 in the test picture It6 according to the brightness sensing information. Therefore, the computing device 130 may determine the upper and lower boundary parameters Y₁, Y₂, Y₃, and Y₄ in the picture boundary parameters according to the positions of the horizontal bars in the test picture It6 in a vertical axis. The vertical axis is Y axis in FIG. 8A.

In an embodiment, the horizontal bar Pa1 in the test picture It6 is located between a Y-axis pixel coordinate Yₐ and a Y-axis pixel coordinate Y_{b} in the vertical axis. And the distance from the Y-axis pixel coordinate Yₐ to the Y-axis pixel coordinate Y_{b} is the width of the horizontal bar Pa1. Accordingly, the computing device 130 may obtain the upper and lower boundary parameter Y₁ according to the Y-axis pixel coordinate Yₐ and the Y-axis pixel coordinate Y_{b}. In an embodiment, the computing device 130 may take other Y-axis pixel coordinates between the Y-axis pixel coordinate Yₐ and the Y-axis pixel coordinate Y_{b} as the upper and lower boundary parameter Y₁. For example, the width of the horizontal bar Pa1 is 8 pixels, if the Y-axis pixel coordinate Yₐ is 8 and the Y-axis pixel coordinate Y_{b} is 15, the computing device 130 may determine that the upper and lower boundary parameter Y₁ is 11. Similarly, the computing device 130 may also obtain the upper and lower boundary parameter Y₃ according to a Y-axis pixel coordinate Y_{c} and a Y-axis pixel coordinate Y_{d} of the horizontal bar Pa2 in the test picture It6 in the vertical axis.

In the scenario of FIG. 8A, in the process of projecting the test pictures It5-It7, brightness information output by the photosensitive elements 120_1 and 120_2 is the same, so the upper and lower boundary parameter Y₁ and the upper and lower boundary parameter Y₂ are determined according to the same pattern position (i.e., the Y-axis pixel coordinate Yₐ and the Y-axis pixel coordinate Y_{b}). In addition, in the process of projecting the test pictures It5-It7, brightness information returned by the photosensitive elements 120_3 and 120_4 is the same, so the upper and lower boundary parameter Y₃ and the upper and lower boundary parameter Y₄ are determined according to the same pattern position (i.e., the Y-axis pixel coordinate Y_{c} and the Y-axis pixel coordinate Y_{d}).

It is worth mentioning that in an embodiment, after performing the flow shown in FIG. 8A, the projection device 110 may scan a range between the Y-axis pixel coordinate Yₐ and the Y-axis pixel coordinate Y_{b} with a narrower horizontal bar (for example, the bar width may be changed from 8 pixels to 4 pixels), so as to acquire more accurate upper and lower boundary parameters.

Next, referring to FIG. 8B, in a vertical alignment calibration period, the pattern may include two vertical bars Pa5 and Pa6, and the positions of the two vertical bars Pa5 and Pa6 will be changed as test pictures It11-It13 are displayed sequentially.

First, the projection device 110 projects the test picture It11. Since the vertical bars Pa5 and Pa6 in the test picture It11 projected by the projection device 110 do not cover the photosensitive elements 120_1-120_4, each of the photosensitive elements 120_1-120_4 senses a second sensing value associated with the black picture background. The photosensitive elements 120_1-120_4 output the second sensing value to the computing device 130, so that the computing device 130 controls the projection device 110 to project the test picture It12. Since the vertical bars Pa5 and Pa6 in the test picture It12 projected by the projection device 110 cover the photosensitive elements 120_1-120_4, each of the photosensitive elements 120_1-120_4 senses a first sensing value associated with the white pattern. The photosensitive elements 120_1-120_4 output the first sensing value to the computing device 130, so that the computing device 130 controls the projection device 110 to project the test picture It13.

Since the vertical bars Pa5 and Pa6 in the test picture It13 projected by the projection device 110 do not cover the photosensitive elements 120_1-120_4, each of the photosensitive elements 120_1-120_4 senses a second sensing value associated with the black picture background. The photosensitive elements 120_1-120_4 output the second sensing value to the computing device 130. In response to the brightness sensing information of the photosensitive elements 120_1-120_4 being changed from the first sensing value to the second sensing value, the computing device 130 may determine left and right boundary parameters X₁, X₂, X₃, and X₄ according to the positions of the two vertical bars Pa5 and Pa6 in the test picture It12. More specifically, by the scanning of the two vertical bars Pa5 and Pa6, the computing device 130 may know that the photosensitive elements 120_1-120_4 are located in a coverage range of the vertical bars Pa5 and Pa6 in the test picture It12 according to the brightness sensing information. Therefore, the computing device 130 may determine the left and right boundary parameters X₁, X₂, X₃, and X₄ in the picture boundary parameters according to X-axis pixel coordinates Xₐ, X_{b}, X_{c}, and X_{d} of the vertical bars Pa5 and Pa6 in the test picture It12 in a horizontal axis. However, the manner of determining the left and right boundary parameters X₁, X₂, X₃, and X₄ is similar to the manner of determining the boundary parameters Y₁, Y₂, Y₃, and Y₄, and descriptions thereof are omitted herein.

It is to be noted that in the scenarios of FIG. 8A and FIG. 8B, the photosensitive elements 120_1-120_4 are simultaneously covered by the horizontal bars Pa1 and Pa2 in the same test picture It6, and the photosensitive elements 120_1-120_4 are simultaneously covered by the vertical bars Pa5 and Pa6 in the same test picture It12, but the invention is not limited thereto. In other application scenarios, the photosensitive elements 120_1-120_4 may be covered by patterns of different test pictures. That is, the upper and lower boundary parameters Y₁, Y₂, Y₃, and Y₄ and the left and right boundary parameters X₁, X₂, X₃, and X₄ corresponding to the four photosensitive elements 120_1-120_4, respectively, may be determined according to different pattern positions in different test pictures.

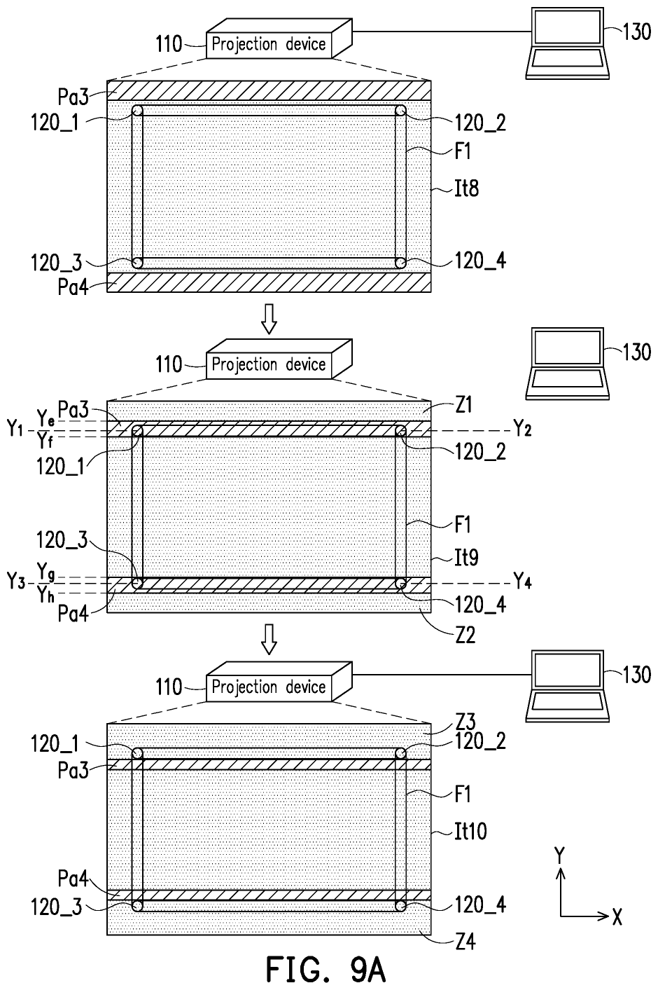

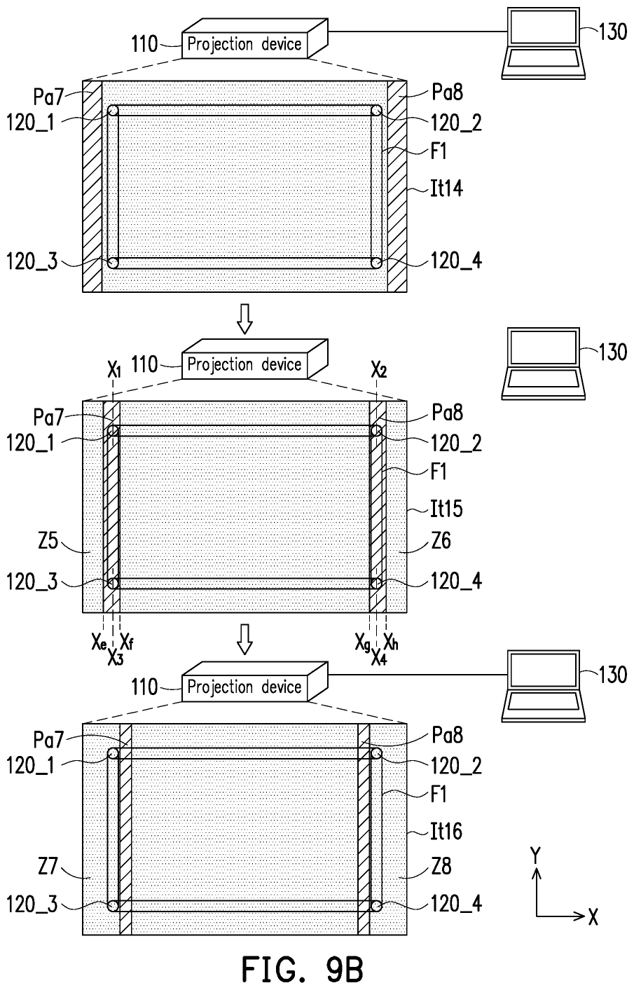

FIG. 9A and FIG. 9B are schematic diagrams of a projection calibration method according to an embodiment of the invention. FIG. 9A and FIG. 9B are exemplified by that a pattern position in the test picture is changed according to a pattern compression deformation parameter and a pattern size is not fixed.

Referring to FIG. 9A, in a horizontal alignment calibration period, by taking test pictures It8-It10 of FIG. 7 as an example, the pattern may include two horizontal bars Pa3 and Pa4, and the positions of the two horizontal bars Pa3 and Pa4 will be changed as the test pictures It8-It10 are displayed sequentially.

First, the projection device 110 projects the test picture It8. Since the horizontal bars Pa3 and Pa4 in the test picture It8 projected by the projection device 110 do not cover the photosensitive elements 120_1-120_4, each of the photosensitive elements 120_1-120_4 senses a second sensing value associated with the black picture background. The photosensitive elements 120_1-120_4 output the second sensing value to the computing device 130, so that the computing device 130 controls the projection device 110 to project the test picture It9. Since the horizontal bars Pa3 and Pa4 in the test picture It9 projected by the projection device 110 cover the photosensitive elements 120_1-120_4, each of the photosensitive elements 120_1-120_4 senses a first sensing value associated with the white pattern. The photosensitive elements 120_1-120_4 output the first sensing value to the computing device 130, so that the computing device 130 controls the projection device 110 to project the test picture It10.

It is to be noted that in an embodiment, peripheral image blocks Z1 and Z2 in the test picture It9 are also black. Since the horizontal bars Pa3 and Pa4 in the test picture It10 projected by the projection device 110 do not cover the photosensitive elements 120_1-120_4, each of the photosensitive elements 120_1-120_4 senses a second sensing value associated with the black picture background (i.e., the peripheral image blocks Z1 and Z2). The photosensitive elements 120_1-120_4 output the second sensing value to the computing device 130. In response to the brightness sensing information of the photosensitive elements 120_1-120_4 being changed from the first sensing value to the second sensing value, the computing device 130 may determine upper and lower boundary parameters Y₁, Y₂, Y₃, and Y₄ according to the positions of the two horizontal bars Pa3 and Pa4 in the test picture It9. More specifically, by the scanning of the two horizontal bars Pa3 and Pa4, the computing device 130 may know that the photosensitive elements 120_1-120_4 are located in a coverage range of the horizontal bars Pa3 and Pa4 in the test picture It9 according to the brightness sensing information. Therefore, the computing device 130 may determine the upper and lower boundary parameters Y₁, Y₂, Y₃, and Y₄ in the picture boundary parameters according to the positions of the horizontal bars in the test picture It9 in a vertical axis. It is to be noted that the widths of the two horizontal bars Pa3 and Pa4 are gradually reduced in response to scaling factors for generating the test pictures It8-It10. Similar to the description of FIG. 8A, the computing device 130 may also obtain the upper and lower boundary parameters Y₁, Y₂, Y₃, and Y₄ according to Y-axis pixel coordinates Yₑ, Y_{f}, Y_{g}, and Y₁, of the horizontal bars Pa3 and Pa4 in the test picture It9 in the vertical axis.

Next, referring to FIG. 9B, in a vertical alignment calibration period, the pattern may include two vertical bars Pa7 and Pa8, and the positions of the two vertical bars Pa7 and Pa8 will be changed as test pictures It14-It16 are displayed sequentially. The test pictures It15-It16 include image blocks Z5, Z6, Z7, and Z8, respectively, and the image blocks Z5, Z6, Z7, and Z8 may be black and regarded as picture backgrounds. Similar to the operation flows of FIG. 8A, FIG. 8B and FIG. 9A, in the process of sequentially displaying the test pictures It14-It16, in response to the brightness sensing information of the photosensitive elements 120_1-120_4 being changed from the first sensing value to the second sensing value, the computing device 130 may determine the left and right boundary parameters X₁, X₂, X₃, and X₄ according to the X-axis pixel coordinates Xₑ, X_{f}, X_{g}, and X₁, of the two vertical bars Pa7 and Pa8 in the test picture It15 in the horizontal axis.

It can be seen from FIG. 8A, FIG. 8B, FIG. 9A, and FIG. 9B that through the operation flows of the horizontal alignment calibration period and the vertical alignment calibration period, the computing device 130 may acquire the upper and lower boundary parameters Y₁, Y₂, Y₃, and Y₄ and the left and right boundary parameters X₁, X₂, X₃, and X₄. Accordingly, the projection device 110 may perform image deformation processing on an image to be projected according to the upper and lower boundary parameters Y₁, Y₂, Y₃, and Y₄ and the left and right boundary parameters X₁, X₂, X₃, and X₄ to generate a calibrated picture, where the image deformation processing may include image scaling or geometric deformation processing, so that four corner coordinates of a picture content boundary in the calibrated picture are (X₁, Y₁), (X₂, Y₂), (X₃, Y₃), and (X₄, Y₄), respectively. Accordingly, by generating the calibrated picture according to the picture boundary parameters, the projection content of the projection device 110 may be aligned with the frame F1.

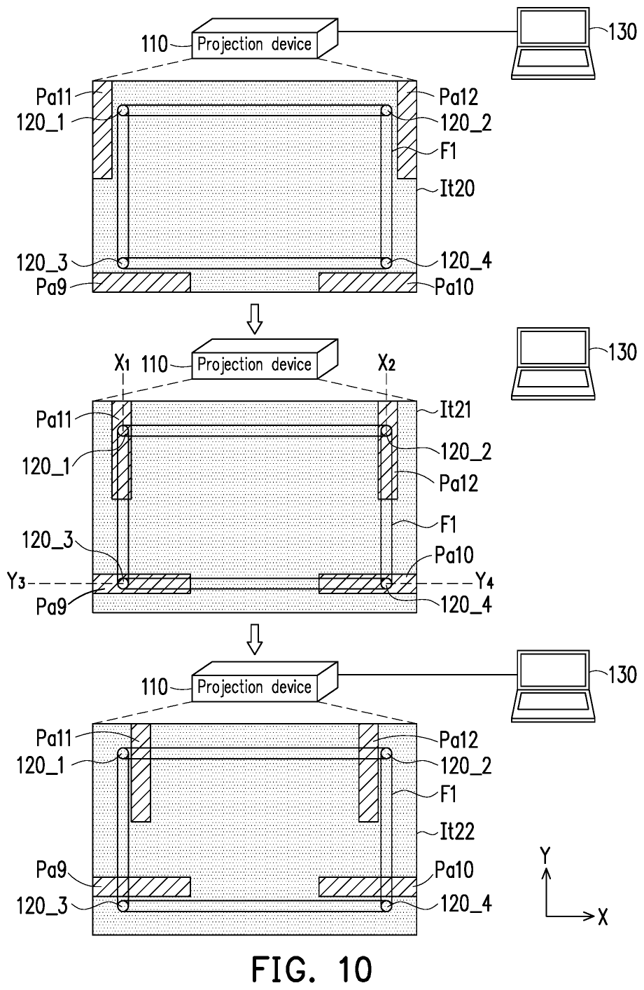

FIG. 10 is a schematic diagram of a projection calibration method according to an embodiment of the invention. FIG. 10 is exemplified by that a pattern position in the test picture is changed according to a pattern position parameter and a pattern size is fixed. Referring to FIG. 10, the pattern may include two horizontal bars Pa9 and Pa10 and two vertical bars Pa11 and Pa12. The positions of the horizontal bars Pa9 and Pa10 and the vertical bars Pa11 and Pa12 will be changed as test pictures It20-It22 are displayed sequentially. The horizontal bars Pa9 and Pa10 are disposed in the lower area of the test pictures It20-It22, and the vertical bars are disposed in the upper area of the test pictures It20-It22.

Similar to the operation flows of FIG. 8A, FIG. 8B, FIG. 9A, and FIG. 9B, in the process of sequentially displaying the test pictures It20-It22, in response to the brightness sensing information of the photosensitive elements 120_1-120_4 being changed from the first sensing value to the second sensing value, the computing device 130 may determine the left and right boundary parameters X₁ and X₂ according to the positions of the two vertical bars Pa11 and Pa12 in the test picture It21 in the horizontal axis, and determine the upper and lower boundary parameters Y₃ and Y₄ according to the positions of the two horizontal bars Pa9 and Pa10 in the test picture It21 in the vertical axis.

In an embodiment, the projection device 110 may perform image scaling according to the left and right boundary parameters X₁ and X₂ and the lower boundary parameters Y₃ and Y₄ to project a calibrated picture aligned with the frame F1. In another embodiment, after the test pictures It20-It22 are displayed sequentially, the projection device 10 will project a plurality of test pictures in which horizontal bars are disposed in the upper area of the pictures and vertical bars are disposed in the lower area of the pictures, so as to acquire the left and right boundary parameters X₃ and X₄ corresponding to the photosensitive elements 120_3 and 120_4 and the upper boundary parameters Y₁ and Y₂ corresponding to the photosensitive elements 120_1 and 120_2 according to the similar operation flow. Then, the projection device 110 may perform image scaling according to the left and right boundary parameters X₁, X₂, X₃, and X₄ and the upper and lower boundary parameters Y₁, Y₂, Y₃, and Y₄ to project a calibrated picture aligned with the frame F1.

However, in an embodiment, before a range defined by the frame F1 is detected using the pattern, environmental detection may be performed to ensure that the arrangement positions of the photosensitive elements 120_1-120_4 are covered by the projection range R1 of the projection device 110, and the environmental light source is taken into consideration to define a first sensing value and a second sensing value suitable for the environment in which the projection system 10 is located.

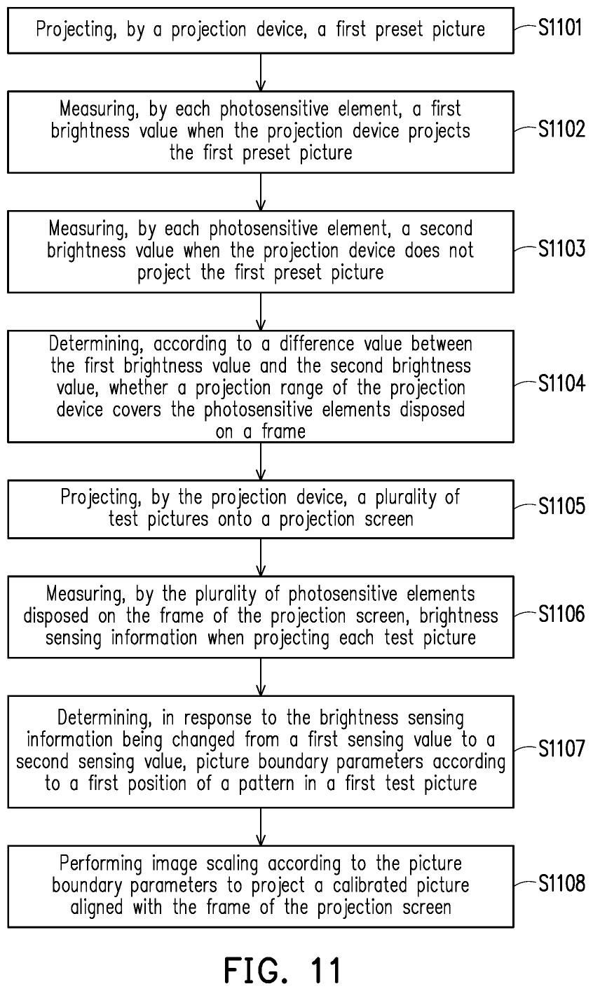

FIG. 11 is a flow chart of a projection calibration method according to an embodiment of the invention. The method flow of FIG. 11 may be implemented by various elements of the projection calibration system 10 of FIG. 1. Referring to FIG. 1 and FIG. 11 together, the steps of the projection calibration method of the embodiment will be described below with reference to various elements of the projection calibration system 10 in FIG. 1.

In step S1101, a projection device 110 projects a first preset picture. The color of the first preset picture is the same as the color of a pattern in a test picture. For example, the first preset picture may be a white picture, and the pattern in the test picture is white. In step S1102, each of photosensitive elements 120_1-120_4 measures a first brightness value when the projection device 110 projects the first preset picture. In step S1103, each of the photosensitive elements 120_1-120_4 measures a second brightness value when the projection device 110 does not project the first preset picture. In an embodiment, each of the photosensitive elements 120_1-120_4 may measures the second brightness value when the projection device 110 projects or does not project a second preset picture. The color of the second preset picture is the same as the color of a picture background in the test picture. For example, the second preset picture may be a black picture, and the picture background in the test picture is black. That is, in an embodiment, the projection device 110 may sequentially project the white picture and the black picture, and the photosensitive elements 120_1-120_4 may respectively sense brightness information of the white picture and the black picture (i.e., the first brightness value and the second brightness value).

In step S1104, a computing device 130 determines, according to a difference value between the first brightness value and the second brightness value, whether a projection range R1 of the projection device 110 covers the photosensitive elements 120_1-120_4 disposed on a frame F1. Specifically, in a case where the projection range R1 covers the photosensitive elements 120_1-120_4 on the frame F1, a difference between the first brightness value generated by brightness sensing of the white picture by the photosensitive elements 120_1-120_4 and the second brightness value generated by brightness sensing of the black picture (or non-projection picture) will be greater than a threshold. Correspondingly, in a case where the projection range R1 does not cover the photosensitive elements 120_1-120_4 on the frame F1, the first brightness value generated by brightness sensing of the first preset picture by the photosensitive elements 120_1-120_4 will be similar to the second brightness value generated by brightness sensing of the second preset picture, and therefore the difference value between the first brightness value and the second brightness value will be less than the threshold. That is, the computing device 130 may determine, according to whether the difference value between the first brightness value and the second brightness value is greater than the threshold, whether the projection range R1 of the projection device 110 covers the photosensitive elements 120_1-120_4 disposed on the frame F1.

After determining that the projection range R1 of the projection device 110 covers the photosensitive elements 120_1-120_4 disposed on the frame F1, the first brightness value and the second brightness value may be used to determine a first sensing value and a second sensing value, and the first sensing value and the second sensing value are then used to determine whether the photosensitive elements 120_1-120_4 are covered by the pattern in the test picture. In other words, by an environment detecting process of steps S1101-S1104, in addition to confirming whether the projection range R1 of the projection device 110 covers the photosensitive elements 120_1-120_4 disposed on the frame F1, the computing device 130 may respectively set the first sensing value and the second sensing value as the first brightness value and the second brightness value measured in an actual projection environment.

In step S1105, the projection device 110 projects a plurality of test pictures onto a projection screen S1. In step S1106, when each test picture is projected, the computing device 130 measures brightness sensing information by means of the plurality of photosensitive elements 120_1-120_4 disposed on the frame F1 of the projection screen S1. In step S1107, in response to the brightness sensing information being changed from the first sensing value to the second sensing value, the computing device 130 determines picture boundary parameters according to a first position of a pattern in a first test picture. In step S1108, the computing device 130 performs image scaling according to the picture boundary parameters to project a calibrated picture aligned with the frame F1 of the projection screen S1.

Based on the foregoing, in the embodiments of the invention, a projection device will project a plurality of test pictures including a pattern onto a projection screen, and a position of the pattern in each test picture is changed when the test pictures are sequentially displayed on the projection screen. Moreover, when the projection device projects the test pictures onto the projection screen, photosensitive elements disposed on a frame of the projection screen are adopted to measure brightness information of the test pictures. Since the position of the pattern changes as the test pictures are displayed sequentially, the positions of the photosensitive elements relative to a projection range may be detected by continuously sensing brightness sensing information. Since the photosensitive elements are disposed on the frame, picture boundary parameters may be determined according to the positions of the photosensitive elements relative to the projection range. Therefore, the projector will perform image scaling according to the picture boundary parameters to generate a calibrated picture that may be aligned with the frame of the projection screen, thereby providing an efficient and convenient projection calibration method.

In addition, in the embodiments of the invention, since a user does not need to manually perform a projection calibration flow and does not need to consider camera parameters and camera calibration, a more convenient and fast projection calibration method is provided. Moreover, accurate picture boundary parameters may be acquired by the scanning of the pattern, thereby further improving the display quality of the projection device. Furthermore, other objectives and advantages of the invention may be further understood from the technical features disclosed in the invention.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A projection calibration system, comprising a projection device, a plurality of photosensitive elements, and a computing device, wherein
the projection device projects a plurality of test pictures onto a projection screen, wherein each of the plurality of test pictures comprises a pattern, and the plurality of test pictures comprises a first test picture and a second test picture;
the plurality of photosensitive elements are disposed on a frame of the projection screen and measure brightness sensing information when the projection device projects each of the plurality of test pictures;
the computing device is coupled to the plurality of photosensitive elements and the projection device;
wherein the brightness sensing information is changed from a first sensing value to a second sensing value in response to the pattern being changed from a first position in the first test picture to a second position in the second test picture,
wherein the computing device determines picture boundary parameters according to the first position of the pattern in the first test picture in response to the brightness sensing information being changed from the first sensing value to the second sensing value, and
the projection device performs image scaling according to the picture boundary parameters to project a calibrated picture aligned with the frame of the projection screen.

2. The projection calibration system according to claim 1, wherein the plurality of photosensitive elements are located at a plurality of corners of the frame of the projection screen, and a projection range of the projection device covers at least the frame.

3. The projection calibration system according to claim 1, wherein the pattern comprises a horizontal bar, and the projection device generates the plurality of test pictures by changing a position of the horizontal bar along a vertical axis.

4. The projection calibration system according to claim 3, wherein the computing device determines upper and lower boundary parameters in the picture boundary parameters according to the first position of the horizontal bar in the vertical axis in the first test picture.

5. The projection calibration system according to claim 1, wherein the pattern comprises a vertical bar, and the projection device generates the plurality of test pictures by changing a position of the vertical bar along a horizontal axis.

6. The projection calibration system according to claim 5, wherein the computing device determines left and right boundary parameters in the picture boundary parameters according to the first position of the vertical bar in the horizontal axis in the first test picture.

7. The projection calibration system according to claim 1, wherein the pattern comprises a horizontal bar and a vertical bar, and the projection device generates the plurality of test pictures by changing a position of the vertical bar along a horizontal axis and a position of the horizontal bar along a vertical axis.

8. The projection calibration system according to claim 1, wherein the projection device reduces a size of an original image from the computing device according to the picture boundary parameters and fills a periphery of the size-reduced original image with a peripheral image block to generate the calibrated picture, and an image edge of the size-reduced original image in the calibrated picture is aligned with the frame.

9. The projection calibration system according to claim 1, wherein the projection device generates the plurality of test pictures according to pattern parameters provided by the computing device, the pattern parameters comprise a pattern position parameter, the projection device generates a plurality of pattern pictures respectively acting as the plurality of test pictures according to the pattern position parameter, and the patterns are respectively located at different positions in the plurality of pattern pictures and have fixed sizes.

10. The projection calibration system according to claim 1, wherein the projection device generates the plurality of test pictures according to pattern parameters provided by the computing device, the pattern parameters comprise a pattern compression deformation parameter, the projection device compresses a pattern picture according to the pattern compression deformation parameter and fills a periphery of the compressed pattern picture with an image block to generate the plurality of test pictures, a position of the pattern in the pattern picture is fixed, and a size of the pattern is reduced according to the pattern compression deformation parameter.

11. The projection calibration system according to claim 1, wherein the projection device further projects a first preset picture, each of the plurality of photosensitive elements measures a first brightness value when the projection device projects the first preset picture and measures a second brightness value when the projection device does not project the first preset picture, and the computing device determines, according to a difference value between the first brightness value and the second brightness value, whether a projection range of the projection device covers the plurality of photosensitive elements disposed on the frame, wherein the first brightness value and the second brightness value are configured for determining the first sensing value and the second sensing value.

12. The projection calibration system according to claim 11, wherein each of the plurality of photosensitive elements measures the second brightness value when the projection device projects or does not project a second preset picture.

13. A projection calibration method, comprising:
projecting, by a projection device, a plurality of test pictures onto a projection screen, wherein each of the plurality of test pictures comprises a pattern, and the plurality of test pictures comprise a first test picture and a second test picture;
measuring, by a plurality of photosensitive elements located on a frame of the projection screen, brightness sensing information when projecting each of the plurality of test pictures, wherein the brightness sensing information is changed from a first sensing value to a second sensing value in response to the pattern being changed from a first position in the first test picture to a second position in the second test picture;
determining, in response to the brightness sensing information being changed from the first sensing value to the second sensing value, picture boundary parameters according to the first position of the pattern in the first test picture; and
performing image scaling according to the picture boundary parameters to project a calibrated picture aligned with the frame of the projection screen.

14. The projection calibration method according to claim 13, wherein the plurality of photosensitive elements are located at a plurality of corners of the frame of the projection screen, and a projection range of the projection device covers at least the frame.

15. The projection calibration method according to claim 13, wherein the pattern comprises a horizontal bar, and the method further comprises: generating the plurality of test pictures by changing a position of the horizontal bar along a vertical axis.

16. The projection calibration method according to claim 15, wherein the step of determining, in response to the brightness sensing information being changed from the first sensing value to the second sensing value, the picture boundary parameters according to the first position of the pattern in the first test picture comprises: determining upper and lower boundary parameters in the picture boundary parameters according to the first position of the horizontal bar in the vertical axis in the first test picture.

17. The projection calibration method according to claim 13, wherein the pattern comprises a vertical bar, and the method further comprises: generating the plurality of test pictures by changing a position of the vertical bar along a horizontal axis.

18. The projection calibration method according to claim 17, wherein the step of determining, in response to the brightness sensing information being changed from the first sensing value to the second sensing value, the picture boundary parameters according to the first position of the pattern in the first test picture comprises: determining, by a computing device, left and right boundary parameters in the picture boundary parameters according to the first position of the vertical bar in the horizontal axis in the first test picture.

19. The projection calibration method according to claim 13, wherein the pattern comprises a horizontal bar and a vertical bar, and the method further comprises: generating the plurality of test pictures by changing a position of the vertical bar along a horizontal axis and changing a position of the horizontal bar along a vertical axis.

20. The projection calibration method according to claim 13, wherein the step of performing image scaling according to the picture boundary parameters to project the calibrated picture aligned with the frame of the projection screen comprises: reducing a size of an original image according to the picture boundary parameters and filling a periphery of the size-reduced original image with a peripheral image block to generate the calibrated picture, an image edge of the size-reduced original image in the calibrated picture being aligned with the frame.

21. The projection calibration method according to claim 13, further comprising:
generating the plurality of test pictures according to pattern parameters, wherein the pattern parameters comprises a pattern position parameter; and
generating a plurality of pattern pictures respectively acting as the plurality of test pictures according to the pattern position parameter, wherein the patterns are respectively located at different positions in the plurality of pattern pictures and have fixed sizes.

22. The projection calibration method according to claim 13, further comprising:
generating the plurality of test pictures according to pattern parameters, the pattern parameters comprising a pattern compression deformation parameter; and
compressing a pattern picture according to the pattern compression deformation parameter and filling a periphery of the compressed pattern picture with an image block to generate the plurality of test pictures, wherein a position of the pattern in the pattern picture is fixed, and a size of the pattern is reduced according to the pattern compression deformation parameter.

23. The projection calibration method according to claim 13, further comprising:
projecting, by the projection device, a first preset picture;
measuring, by each of the plurality of photosensitive elements, a first brightness value when the projection device projects the first preset picture;
measuring, by each of the plurality of photosensitive elements, a second brightness value when the projection device does not project the first preset picture; and
determining, according to a difference value between the first brightness value and the second brightness value, whether a projection range of the projection device covers the plurality of photosensitive elements on the frame, wherein the first brightness value and the second brightness value are configured for determining the first sensing value and the second sensing value.

24. The projection calibration method according to claim 23, further comprising: measuring, by each of the plurality of photosensitive elements, the second brightness value when the projection device projects or does not project a second preset picture.
